(19) United States
(12) Patent Application Publication
(10) Pub. No.: US 2013/0202741 A1
(43) Pub. Date: Aug. 8, 2013

(54) REDUCED FAT FOOD PRODUCT

(71) Applicant: Joy Simpson, Denver, CO (US)

(72) Inventor: Joy Simpson, Denver, CO (US)

(73) Assignee: Dean Foods Company, Dallas, TX (US)

(21) Appl. No.: 13/369,046

(22) Filed: Feb. 8, 2012

(51) Int. Cl. A23C 9/154; A23D 9/00; A23L 1/22; A23C 9/158; A23L 1/304; A23L 1/30; A23C 21/00; A23C 9/18; A23L 2/02; A23L 1/302

(52) U.S. Cl. 426/72; 426/580; 426/599; 426/601; 426/650; 426/74; 426/648; 426/654; 426/583; 426/586; 426/588

(57) ABSTRACT

In one embodiment, a reduced fat food product includes a base system and a fat-mimicking system that imparts a characteristic associated with a higher fat content food product. The base system includes one or more ingredients selected from the group consisting of dairy ingredients, water, juices, oils, sweeteners, vitamins, minerals, nutrients, flavors, colorants, and preservatives. The fat-mimicking system includes microcrystalline cellulose, sodium carboxymethyl cellulose, and one or more buffering agents. The reduced fat food product is substantially free of an additional emulsifier.

### TECHNICAL FIELD OF THE DISCLOSURE

This invention relates in general to food products and, more particularly, to a reduced fat food product with taste and mouthfeel similar to a food product with higher fat content.

### BACKGROUND

Food products, such as dairy beverages and dairy creamers, may contain relatively high levels of milk fat. These products with higher levels of fat may also contain higher levels of calories, which may be considered unfavorable to health or diet conscious consumers. Thus, a food product with lower fat content may be preferred to one with higher fat content by some consumers. However, removing fat from food products may cause an undesirable change in the flavor and/or mouthfeel of the product. For example, some food products with reduced fat content may have a thin mouthfeel that consumers do not enjoy.

### SUMMARY

In one embodiment, a reduced fat food product includes a base system and a fat-mimicking system that imparts a characteristic associated with a higher fat content food product. The base system includes one or more ingredients selected from the group consisting of dairy ingredients, water, juices, oils, sweeteners, vitamins, minerals, nutrients, flavors, colorants, and preservatives. The fat-mimicking system includes microcrystalline cellulose, sodium carboxymethyl cellulose, and one or more buffering agents. The reduced fat food product is substantially free of an additional emulsifier.

Certain embodiments of the present disclosure may provide one or more technical advantages. As an example, in some embodiments, the amount of fat in a food product may be reduced while still maintaining the mouthfeel and taste characteristics associated with higher fat content food products.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and its advantages, reference is now made to the following description, taken in conjunction with the accompanying drawings, in which:

FIG. 1 illustrates an example of a system for producing a reduced fat food product; and

FIG. 2 illustrates an example of a method for producing a reduced fat food product.

### DETAILED DESCRIPTION

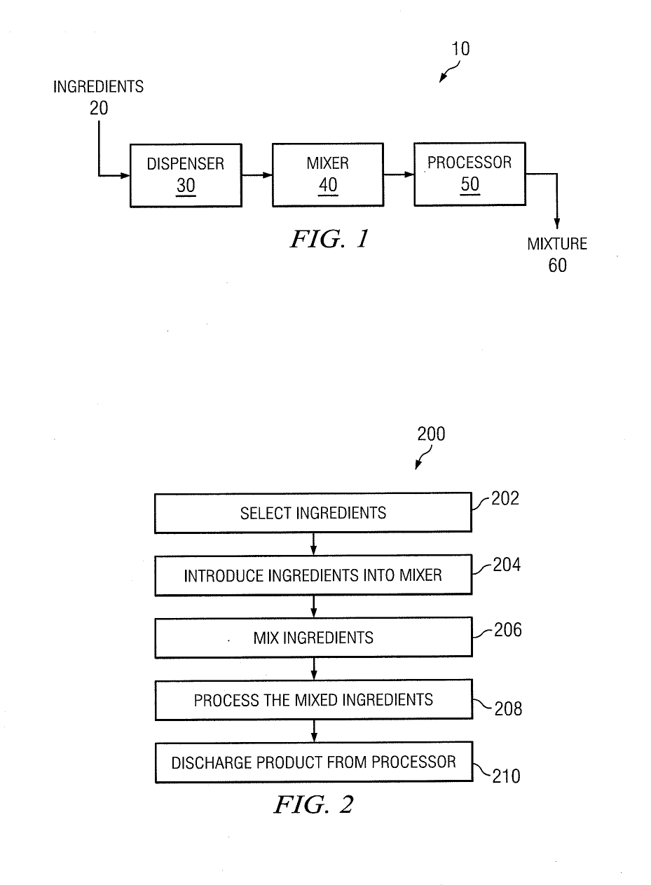

Embodiments of the present invention and its advantages are best understood by referring to FIGS. 1 to 2 of the drawings, like numerals being used for like and corresponding parts of the various drawings.

Food products, such as dairy beverages and dairy creamers, may contain relatively high levels of milk fat. These products with higher levels of fat may also contain higher levels of calories, which may be considered unfavorable to health or diet conscious consumers. Thus, a food product with lower fat content may be preferred to one with higher fat content by some consumers. However, removing fat from food products may cause an undesirable change in the flavor and/or mouthfeel of the product. For example, some food products with reduced fat content may have a thin mouthfeel that consumers do not enjoy. Certain embodiments of the present disclosure may provide a solution to these and other problems. For example, in some embodiments, a fat-mimicking system may allow the amount of fat in a food product to be reduced while still maintaining the mouthfeel and taste characteristics associated with higher fat content food products.

As an example, a dairy creamer may typically include cream to impart flavor and mouthfeel that consumers enjoy. Unfortunately, increasing the amount of cream in the creamer causes the fat content to increase. In certain embodiments of the present disclosure, however, the amount of cream required to impart the desired flavor and mouthfeel to the creamer may be reduced by using the fat-mimicking system. That is, in some embodiments, the fat-mimicking system may be used in lieu of cream that would otherwise be added to the product. Accordingly, the fat-mimicking system may serve to impart the flavor profile or other characteristic of a higher fat food product into a similar reduced fat food product. In certain embodiments, the fat-mimicking system may be used in a dairy product without requiring additional emulsifiers and/or stabilizers.

FIG. 1 illustrates an example of a system 10 for producing a reduced fat food product. In some embodiments, system 10 may include one or more ingredients 20, one or more dispensers 30, a mixer 40, a processor 50, and product 60. In operation, an operator of system 10 selects appropriate ingredients 20 for the desired product 60, and one or more dispensers 30 introduce the selected ingredients 20 into mixer 40. After an appropriate mixing time, the mixture may be discharged into processor 50 manually or through one or more nozzles, hoses, spigots, or other appropriate discharging outlet. Processor 50 processes the mixture to yield product 60.

Ingredients 20 represent constituent elements of product 60 that are deposited, mixed or combined, and discharged from mixer 40. In some embodiments, ingredients 20 of a reduced-fat food product 60 may comprise base system ingredients and fat-mimicking system ingredients. The base system may impart base properties that are characteristic of the desired product 60. As an example, if product 60 is a dairy creamer, the base system may include ingredients 20 such as cream, milk, sweeteners, whiteners (e.g., titanium dioxide), stabilizers, flavors, nutrients, and/or other ingredients characteristic of a dairy creamer. In general, depending on the desired product 60, base system may include dairy ingredients, water, juices, oils, sweeteners, vitamins, minerals, nutrients, flavors, colorants, preservatives, and/or other suitable ingredients.

The fat-mimicking system may impart the reduced-fat food product 60 with a characteristic associated with a comparable higher fat content. Examples of characteristics associated with a higher fat content include viscosity, particle size, texture, mouthfeel, and/or flavor. Additionally, in certain embodiments, the fat-mimicking system may act as a stabilizer to prevent separation or precipitation of the product 60 once deposited in a package or container. Ingredients 20 of fat-mimicking system may include microcrystalline cellulose, sodium carboxymethyl cellulose, and one or more buffering agents (e.g., buffering salts). When added, to the base system, the combination of microcrystalline cellulose, sodium carboxymethyl cellulose, and buffering agents may take on characteristics that mimic those of fat. As an example, when used in a dairy creamer, the combination of microcrystalline cellulose, sodium carboxymethyl cellulose, and buffering agents may impart a creamy taste and/or mouthfeel that is similar to milk fat or butterfat. Accordingly, in certain embodiments, the fat-mimicking system may be added to the dairy creamer in lieu of a certain portion of one or more dairy ingredients.

Dispensers 30 measure ingredients 20, hold ingredients 20 prior to dispensing, pre-combine certain ingredients (e.g., dry ingredients), maintain ingredients 20 at a particular temperature, and/or dispense ingredients 20 into mixer 40. Ingredients 20 may be added serially (i.e., one at time), collectively (i.e., all ingredients are added substantially at once), or as a combination (i.e., certain subsets of ingredients are pre-combined, and the combination is added serially with other ingredients or ingredient combinations). For example, in some embodiments, a base system may be added to the mixer prior to the fat-mimicking system. However, in other embodiments, the base system and fat-mimicking system may be added to the mixer simultaneously. In particular embodiments, the ingredients of the fat mimicking system may be added to the mixer between certain ingredients of the base system. As an example, a dairy ingredient may be added to the mixer, then one or more of the ingredients of the fat-mimicking system, followed by the remaining ingredients of the mixture, such as flavors, colorants, and/or preservatives.

Ingredients 20 may be dispensed from dispenser 30 manually or through one or more nozzles, hoses, spigots, or other appropriate discharging outlet. In some embodiments, mixer 40 may combine ingredients 20. Mixer 40 may comprise any appropriate container suitable to receive, mix, and/or discharge one or more ingredients 20. In particular embodiments, mixer 40 may comprise a stainless steel chamber of any suitable size. For example, mixer 40 may be sized to mix ingredients 20 in large batches that may later be divided into smaller sizes suitable for sales to consumers, or mixer 40 may be sized to mix smaller, individual-sized portions.

Mixer 40 may receive ingredients 20 through one or more different inlets. For example, some ingredients (e.g., water, oils, dairy milk, cream, non-dairy milk alternatives, etc.) may be added to the mixing chamber through one or more nozzle and hose inlets, and other ingredients 20, such as sweeteners, flavors, and/or ingredients of the fat-mimicking system, may be added through one or more openings in mixer 40. Mixer 40 may include one or more means for blending, mixing, combining, stirring, and/or agitating ingredients 20. For example, mixer 40 may include mechanical agitators, pressure jets, or other suitable mixing devices, whether located within mixer 40 or external to mixer 40. Alternatively, mixer 40 may allow for stirring or mixing by hand. In some embodiments, mixer 40 may be a static or motionless mixer.

In some embodiments, mixer 40 may be chilled (depending on the particular ingredients 20 used) to prevent spoliation of one or more ingredients 20 during mixing and/or processing. Accordingly, mixer 40 may include a jacketed or insulated tank to maintain appropriate temperatures. Mixer 40 may also include one or more discharge outlets connected to other components of system 10. For example, mixer 40 may include one or more discharge outlets connected to hoses or tubes, which may carry the mixture to processor 50.

Processor 50 may comprise one or more' components for further processing the mixture. Examples of processing components may include one or more of, pasteurizers, homogenizers, filtration systems, sonication systems, or other processing components. A pasteurizer may include means for pasteurizing the mixture. Pasteurization may refer to heating the product to a temperature (e.g., 160 to 295° F.) and holding it at the temperature for a period of time (e.g., 1 to 30 seconds) to reduce the number of viable pathogenic micro-organisms in the product. Examples of pasteurization techniques include high temperature short time pasteurization (HTST), ultra pasteurization (UP), ultra high temperature pasteurization (UHT), and high pressure pasteurization (HPP).

A homogenizer may reduce particle size so that particle distribution may be maintained and mouthfeel may be improved. For example, a homogenizer may force particles through an orifice at a high pressure in order to shear the particles. In certain embodiments, the homogenization pressure may be between approximately 0 to 5,500 pounds per square inch (psi), 5,500 to 10,000 psi, or greater than 10,000 psi. In certain embodiments, multiple-stage homogenization may be used, such as two-stage homogenization. In the first stage, the homogenization pressure may be between approximately 0 to 5,500 psi, and in the second stage the homogenization pressure may be between approximately 0 to 1,000 psi. In other embodiments, ultra high pressure (UHP) homogenization may be used. For example, the homogenization pressure in UHP may be greater than approximately 5,500 psi, such as greater than 10,000 psi, for example, greater than 20,000 psi. The product may be homogenized prior to and/or after pasteurization.

Processor 50 may optionally include a filtration system and/or a sonication system. A filtering system filters and/or separates certain suspended particles in the mixture. A sonication system may mix, homogenize, and/or emulsify the mixture.

In some embodiments, product 60 may be directed from processor 50 to temperature controlled storage or to packaging, bottling, or filling components suitable to ready product 60 for commercial sale or use. For example, packaging components may deposit an amount of the product into one or more bottles, jars, cans, cartons, and/or any other appropriate container. In certain embodiments, product 60 may have a pH ranging from approximately 6.5 to 9.0.

In particular embodiments, product 60 comprises a flavored or non-flavored dairy based creamer. In general, however, product 60 may represent any reduced fat food product. In particular embodiments, system 10 may provide a reduced fat product 60 that has a flavor and mouthfeel profile similar to a comparable higher fat product. Particular embodiments may provide some, none, or all of these operational benefits, and may provide additional operational benefits.

Modifications, additions, or omissions may be made to system 10 without departing from the scope of the invention. The components of system 10 may be integrated or separated. Moreover, the operations of system 10 may be performed by more, fewer, or other components.

FIG. 2 is a flow diagram illustrating a method 200 for making a reduced fat food product. The method begins at step 202 where appropriate ingredients are selected. Ingredients may include base system ingredients and fat-mimicking system ingredients. The base system ingredients may include dairy ingredients, water, juices, oils, sweeteners, vitamins, minerals, nutrients, flavors, colorants, and/or preservatives.

Dairy ingredients may include skim milk, 1% milk, 2% milk, whole milk, cream, butterfat, lactose free milk, dairy proteins, nonfat dried milk (NFDM), milk powders, other dairy powders, or any other suitable dairy ingredient. In certain embodiments, the dairy ingredients may comprise more than 75%, more than 85%, or more than 95% of the product.

Juice may include fruit juice or vegetable juice. In addition, juice may refer to other plant-derived beverages, such as soy milk, almond milk, rice milk, coconut milk, etc. In some embodiments, juice may comprise a main ingredient of the product, for example, in an amount more than 50%, more than 75%, more than 85%, or more than 95% of the product. In alternative embodiments, juice may comprise an accent ingredient in an amount less than 50%, less than 25%, less than 15%, or less than 5%, or 0% of the product. As an example, juice may comprise an accent ingredient in a dairy-based smoothie or a flavored water beverage.

Sweeteners may be natural, artificial, and/or non-nutritive and may function to make the products taste more appealing. Examples of natural nutritive sweeteners include sugar, liquid sugar, crystallized sugar, honey, agave, cane juice, high fructose corn syrup, and corn syrup. Examples of natural non-nutritive sweeteners may include luo han guo, stevia, or their derivatives. Examples of artificial non-nutritive sweeteners include sucralose, aspartame, and saccharine. Non-nutritive sweeteners may be used as a low-calorie alternative to nutritive sweeteners. Each sweetener may be used alone or in combination with one or more other sweeteners of the same or different type. In certain embodiments, the sweeteners may comprise less than 50%, less than 45%, less than 35%, less than 20%, less than 10%, less than 5%, less than 1%, or 0% of the product.

Vitamins, minerals, or other nutrients may be added to fortify the product. Examples include A, vitamin D, vitamin E, vitamin B6, vitamin B12, vitamin C, iron, potassium, phosphorous and/or calcium, however, any suitable vitamins and/or minerals may be used. Any suitable ingredient may be used as a vitamin or mineral source. The vitamin and mineral sources may be selected so that sodium levels in the product do not spike and that proper pH levels are maintained. The amount of vitamins and minerals may be selected to provide a desired level of fortification, for example, based on daily recommended values (DRVs). Other nutrients such as proteins (e.g., pea, soy, rice, and/or whey protein), amino acids, carbohydrates (e.g., fiber), and/or fats (e.g., poly unsaturated fatty acids) may also be added for further fortification of the product.

Natural and artificial flavors and flavoring ingredients including extracts of plant materials, cocoa powder, milk based ingredients, alcoholic or non alcoholic extracts, cocoa, fruit juices, concentrates, and compounded flavors, impart desired taste attributes to products. In certain embodiments, flavors may include flavoring salts (e.g., sea salt, sodium chloride). They are used at various levels depending on the strength and the desired end product attributes. Examples of flavors may include, but are not limited to, amaretto, chocolate, cocoa, cream, toffee, almond, vanilla, hazelnut, caramel, Irish crème, butter pecan, mint, cinnamon, pumpkin, strawberry, raspberry, other fruit flavorings. Approximate ranges of flavoring ingredients may vary from 0 to 5% depending on desired product properties.

Colorants impart a desired color to the product. For example, titanium dioxide may be used to impart a white color to a product. Other examples of colorants may include FD&C colors, natural colors, dyes, and lakes.

Preservatives may preserve the flavor and appearance of the product during refrigerated and/or unrefrigerated storage. Preservatives may include antimicrobial preservatives, which may inhibit bacteria and/or fungal growth in the food product. Examples of antimicrobial preservatives include calcium propionate, sodium nitrate, sodium nitrite, sulfur dioxide, sodium bisulfite, potassium hydrogen sulfite, and the like. Preservatives may also include antioxidants, which may prevent and/or reduce oxidation in the food product. Examples of antioxidants may include BHA, BHT, propyl gallate, tocopherols, and salts of ascorbic acid, such as sodium ascorbate.

In some embodiments, the fat-mimicking system includes microcrystalline cellulose, sodium carboxymethyl cellulose, and one or more buffering agents. Examples of buffering agents include, but are not limited to, citrate salts (e.g., sodium citrate, potassium citrate, etc.) and phosphate salts (e.g., potassium phosphate, sodium phosphate, etc.). In certain embodiments, the fat-mimicking system may comprise less than 2%, less than 1%, or less than 0.5% of the product. In some embodiments, fat-mimicking system may be formed from one or more pre-blends. As an example, a first pre-blend may include microcrystalline cellulose and sodium carboxymethyl cellulose and a second pre-blend may include disodium phosphate and sodium citrate. In certain embodiments, the first pre-blend includes approximately 50 to 70%, 70 to 95%, or 95 to 99% microcrystalline cellulose, with sodium carboxymethyl cellulose making up the rest of the first pre-blend. In certain embodiments, the first pre-blend makes up approximately 35 to 45%, 45 to 55% (e.g., 45 to 48%, 48 to 50%, 50 to 52%, or 52 to 55%), or 55 to 65% of the fat-mimicking system, with the second pre-blend making up the rest of the fat-mimicking system.

As described above, the fat-mimicking system may be operable to impart a characteristic associated with a higher fat content to the base system. For example, a reduced fat food product comprising the base system and the fat-mimicking system may have a similar flavor and/or mouthfeel to that of a similar food product having a higher fat content. In certain embodiments, the fat-mimicking system may be combined with a base system consisting essentially of dairy ingredients in order to impart a reduced-fat dairy product with a flavor and/or mouthfeel similar to a higher fat dairy product.

The following tables illustrate examples of a reduced fat food product. Dry ingredients, if any, may be weighed according to the formula and blended together. Embodiments of the present disclosure may add or omit certain ingredients and/or increase or decrease the amount of each ingredient in order to yield the desired properties.

Table 1 illustrates an example in which the base system includes one or more dairy ingredients and optionally includes vitamins, minerals, nutrients, flavors, colorants, and/or preservatives. The fat-mimicking system comprises microcrystalline cellulose, sodium carboxymethyl cellulose, and one or more buffering agents.

TABLE 1

| | | |
|---|---|---|
| | APPROXIMATE | EXAMPLE |
| INGREDIENT | RANGE | RANGE |

Base System

| | | |
|---|---|---|
| Dairy ingredients | 80%-99.9% | 95%-99.9% |
| Vitamins | 0%-2% | 0.1%-1% |
| Minerals | 0%-2% | 0.1%-1% |
| Nutrients | 0%-2% | 0.1%-1% |
| Flavors | 0%-2% | 0.1%-1% |
| Colorants | 0%-2% | 0.1%-1% |
| Preservatives | 0%-2% | 0.1%-1% |

Fat-Mimicking System

| | | |
|---|---|---|
| Microcrystalline Cellulose | 0%-2% | 0.1%-1% |
| Sodium CMC | 0%-2% | 0.1%-1% |
| Buffering agents | 0%-2% | 0.1%-1% |

Table 2 illustrates an example in which the base system includes milk, cream, and optionally whitener. The fat-mimicking system comprises microcrystalline cellulose, sodium carboxymethyl cellulose, and one or more buffering agents.

TABLE 2

| | APPROXIMATE | EXAMPLE |
|---|---|---|
| INGREDIENT | RANGE | RANGE |
| Milk | 60%-90% | 65%-80% |
| Cream | 10%-50% | 20%-35% |
| Whitener | 0-0.5% | 0.05-0.3% |
| Microcrystalline Cellulose | 0.01%-2% | 0.1%-0.5% |
| Sodium Carboxymethyl Cellulose | 0.01%-2% | 0.1%-0.5% |
| Buffering agents | 0.01%-2% | 0.1%-0.5% |

At step 204, the ingredients may be introduced into the mixing chamber. In certain embodiments, the ingredients may be heated to a temperature greater than 100° F., greater than 120° F., or greater than 160° F. to facilitate mixing. As noted above, ingredients 40 may be added serially, collectively, or a combination of both.

At step 206, the ingredients may be mixed or combined in any appropriate manner to facilitate dispersing the ingredients substantially evenly throughout and dissolution of the dry ingredients, if any, in the mixture. For example, mechanical agitators, pressure jets, or other suitable mixing devices may be used to stir, mix, blend, agitate, or otherwise combine the ingredients. As another example, the ingredients may be stirred or mixed by hand. As another example, a motionless mixer may be used to mix the ingredients. Mixing may continue until the ingredients are distributed substantially evenly throughout the product.

At step 208, the mixture may be discharged from the mixing chamber. The mixture may then be directed to one more processing components, such as a filtration system, a sonication system, a pasteurizer, and/or a homogenizer. At step 210, the mixture may be processed using the processing components. The finished product may then be packaged and stored in refrigerated or unrefrigerated storage at step 212. In some embodiments, the flavor and texture of the finished product may be substantially maintained throughout the shelf-life of the product. As an example, the shelf-life of the reduced fat food product may be between approximately 1 week to 1 year, such as 3 to 6 months, if the package is unopened or 1 to 3 weeks after opening the package.

The method of producing a reduced fat food product may yield a product having fewer fat and calories than other, higher fat products while imparting a taste and/or mouthfeel similar to the higher fat products. In certain embodiments, the fat-mimicking system may allow for reducing fat by 1 to 10%, 10 to 20%, 20 to 30%, 30 to 40%, or 40 to 50% while substantially maintaining taste and mouthfeel. As an example, reducing the fat content of an 18% fat creamer by about twenty percent and adding the fat-mimicking system may yield a reduced fat creamer containing less than approximately 15% fat and having a flavor and mouthfeel similar to the 18% fat creamer. In some embodiments, the reduced fat creamer may comprise 20-25% total solids (e.g., butterfat and milk solids nonfat imparted by the dairy ingredients, such as milk and cream).

The steps illustrated in FIG. 2 may be combined, modified, or deleted where appropriate, and additional steps may also be added to those shown. Additionally, the steps may be performed in any suitable order without departing from the scope of the present disclosure.

Certain embodiments of the present disclosure may provide one or more technical advantages. As an example, a fat-mimicking system may impart a characteristic of a higher fat content to a reduced fat food product. In certain embodiments, the ingredients in the fat-mimicking system consist of microcrystalline cellulose, sodium carboxymethyl cellulose, and one or more buffering agents. The fat-mimicking system may be substantially free of other ingredients.

The ingredients in the base system may be substantially similar to the ingredients in a similar higher fat food product. As an example, if the similar higher fat food product comprises milk, cream, and optionally colorant (e.g., titanium dioxide), the base system of the reduced fat food may also comprise milk, cream, and optionally colorant. The amount of each ingredient may be selected to yield a desired fat content. For example, the base system of the reduced fat food product may comprise less cream (and thus less butterfat) than the similar higher fat food product. In certain embodiments, producing a reduced fat food product comprising only the fat-mimicking system, dairy ingredients, and optionally colorant may minimize the total number of ingredients required for a reduced fat food product. Minimizing the number of ingredients may reduce certain costs and complexities associated with producing the food product. Additionally, health conscious consumers may prefer food products that contain primarily natural ingredients that are familiar to the consumers. Although the preceding example describes the base system as including milk, cream, and colorant, the base system may include any suitable ingredients.

In certain embodiments, the base system comprises one or more ingredients selected from the group consisting of: dairy ingredients, water, juices, oils, sweeteners, vitamins, minerals, nutrients, flavors, colorants, and preservatives, but is free (or substantially free) of additional emulsifiers and/or additional stabilizers. That is, the base system may provide sufficient emulsification to the product such that the inclusion of additional emulsifiers is not necessary. As an example, in some embodiments, the base system may include certain emulsifiers to the extent that they are naturally occurring in the base ingredients. For example, milk or soy may naturally include components with emulsifying properties. However, the base system may be free (or substantially free) of added emulsifiers that have been extracted and/or concentrated for increased emulsification, such as mono- and di-glycerides, partial glycerol ester, acetic acid esters of monoglycerides, lactic acid esters of monglycerides, citric acid esters of monglycerides, succinic acid esters of monoglycerides, diacetyl tartaric acid esters of monoglycerides, polyglycerol esters of fatty acids, polyglycerol polyricinoleate, sorbitan esters of fatty acids, propylene glycol esters of fatty acids, calcium stearoyl di laciate, lecithin, enzyme digested lecithin, and/or derivatives of the preceding.

Similarly, in some embodiments, the fat-mimicking system (microcrystalline cellulose, sodium carboxymethyl cellulose, and buffering agents) may provide sufficient stability to the product such that the inclusion of additional stabilizers is not necessary. Accordingly, the product may be free (or substantially free) of additional stabilizers, such as thickeners, starches (e.g., modified food starch, native food starch, etc.), and various gums and/or hydrocolloids such as guar, acacia, locust bean, xanthan, gellan, carrageenan, and pectin. In alternate embodiments, the product may include suitable stabilizers.

Although the present disclosure has been described with several embodiments, numerous changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. A reduced fat food product, comprising:
a base system comprising one or more ingredients selected from the group consisting of: dairy ingredients, water, juices, oils, sweeteners, vitamins, minerals, nutrients, flavors, colorants, and preservatives; and
a fat-mimicking system comprising microcrystalline cellulose, sodium carboxymethyl cellulose, and one or more buffering agents;
wherein the reduced fat food product is substantially free of an additional emulsifier.

2. The reduced fat food product of claim 1, wherein the fat-mimicking system consists of:
a first blend comprising the microcrystalline cellulose and the sodium carboxymethyl cellulose; and
a second blend comprising the buffering agents, the buffering agents consisting essentially of disodium phosphate and sodium citrate;
wherein the first blend makes up approximately 45-55% of the fat-mimicking system and the second blend makes up the remainder of the fat-mimicking system, the fat-mimicking system comprising less than 0.5% of the reduced fat food product.

3. The reduced fat food product of claim 2, the one or more dairy ingredients present in an amount comprising at least 95% of the reduced fat food product.

4. The reduced fat food product of claim 1, a viscosity of the reduced fat food product greater than or substantially equal to a viscosity of a comparable food product, the comparable food product having a fat content at least 1.2 times the fat content of the reduced fat food product.

5. The reduced fat food product of claim 1, wherein the reduced fat food product comprises less than 20% fat.

6. The reduced fat food product of claim 1, the one or more buffering agents selected from the group consisting of citrate salts and phosphate salts.

7. The reduced fat food product of claim 6, wherein the reduced fat food product is substantially free of additional stabilizers.

8. The reduced fat food product of claim 1, wherein the pH of the food product is in the range of 6.5 to 9.0.

9. The reduced fat food product of claim 1, comprising 0.0001 to 10% of a combination of dairy ingredients comprising one or more of: milk solids nonfat, whey powder, and other dairy powders.

10. The reduced fat food product of claim 1, further comprising one or more of: carrageenan, guar gum, locust bean gum, modified food starch, gellan gum, native food starch, and xanthan gum.

11. A reduced fat food product, comprising:
a base system comprising one or more ingredients selected from the group consisting of:
milk present in an amount between approximately 65 and 80% of the reduced fat food product;
cream present in an amount between approximately 20 and 35% of the reduced fat food product; and
a secondary ingredient selected from the group consisting of: colorants, sweeteners, flavors, vitamins, minerals, nutrients, preservatives, and other dairy ingredients; and
a fat-mimicking system present in an amount less than 2% of the reduced fat food product, the fat-mimicking system comprising:
one or more buffering agents; and
a blend comprising microcrystalline cellulose and sodium carboxymethyl cellulose, the blend present in an amount between approximately 45 and 55% of the fat-mimicking system;
the reduced fat food product substantially free of other ingredients.

12. The reduced fat food product of claim 11, wherein the reduced fat food product does not include any of the secondary ingredients.

13. The reduced fat food product of claim 11, wherein the secondary ingredients exclude sweeteners.

14. The reduced fat food product of claim 11, wherein the secondary ingredients exclude vitamins, minerals, and nutrients.

15. The reduced fat food product of claim 11, wherein the secondary ingredients exclude sweeteners, vitamins, minerals, nutrients, and preservatives.

16. The reduced fat food product of claim 15, wherein the secondary ingredients exclude flavors.

17. The reduced fat food product of claim 11, the one or more buffering agents selected from the group consisting of: citrate salts and phosphate salts.

18. The reduced fat food product of claim 11, wherein the one or more buffering agents consist essentially of sodium citrate and disodium phosphate.

19. The reduced fat food product of claim 11, wherein the reduced fat food product comprises a creamer having a fat content less than 15%.

20. The reduced fat food product of claim 19, wherein the reduced fat food product comprises 20-25% total solids, the total solids comprising butterfat and milk solids nonfat imparted by the milk and the cream.
